(19) United States
(12) Patent Application Publication
(10) Pub. No.: US 2023/0258456 A1
(43) Pub. Date: Aug. 17, 2023

(54) INERTIAL SENSOR

(71) Applicant: Panasonic Intellectual Property Management Co., Ltd., Osaka (JP)

(72) Inventor: Shinichi KISHIMOTO, Fukui (JP)

(21) Appl. No.: 18/002,005

(22) PCT Filed: Jun. 24, 2021
(86) PCT No.: PCT/JP2021/023940

§ 371 Date: Dec. 15, 2022

(30) Foreign Application Priority Data
Jun. 24, 2020 (JP) 2020-109127

(51) Int. Cl. G01C 21/28; G01C 21/16; G01C 21/18; G01C 19/5776

(52) U.S. Cl. CPC G01C 21/28; G01C 21/166; G01C 21/18; G01C 19/5776

(57) ABSTRACT

An inertial sensor includes: a plurality of inertial force detection elements each configured to output an output signal corresponding to a detected inertial force; and a processor configured to execute processing relating to the output signal from each of the plurality of inertial force detection elements. The plurality of inertial force detection elements include a first inertial force detection element and a second inertial force detection element. A detection range of the first inertial force detection element and a detection range of the second inertial force detection element are different from each other. A sensitivity of the first inertial force detection element and a sensitivity of the second inertial force detection element are different from each other.

### CROSS REFERENCE TO RELATED APPLICATIONS

This application is the U.S. National Phase under 35 U.S.C. § 371 of International Patent Application No. PCT/JP2021/023940, filed on Jun. 24, 2021 which in turn claims the benefit of Japanese Patent Application No. 2020-109127, filed on Jun. 24, 2020, the entire disclosures of which Applications are incorporated by reference herein.

### TECHNICAL FIELD

The present disclosure relates to inertial sensors. Specifically, the present disclosure relates to an inertial sensor for use in various electronic devices.

### BACKGROUND ART

Patent Literature 1 discloses an angular velocity sensor element for use in angular velocity sensors for use in various electronic devices. The angular velocity sensor element of Patent Document 1 includes a pair of fixed portions; a first drive arm whose one end is supported by one fixed portion of the pair of fixed portions; a second drive arm whose one end is supported by the other fixed portion of the pair of fixed portions, the second drive arm being continuous with the first drive arm; a plumb portion supported by the other end of the first drive arm and the other end of the second drive arm; a connector connecting both of the pair of fixed portions to each other; a driving electrode provided with a piezoelectric layer which is provided to one or both of the first drive arm and the second drive arm and which is configured to drive and vibrate the plumb portion in a direction connecting the fixed portion and the plumb portion to each other; and a detection electrode provided with a piezoelectric layer which is provided to one or both of the first drive arm and the second drive arm and which is configured to detect Coriolis force generated at the first drive arm and the second drive arm.

In the angular velocity sensor element of Patent Literature 1, which is a type of inertial force detection elements, enlarging (increasing the weight of) the plumb portion makes significant a change in an electric signal from the detection electrode in response to a change in the angular velocity, thereby improving sensitivity. However, enlarging (increasing the weight of) the plumb portion narrows an angular velocity range (detection range) within which the linearity of the change in the electric signal from the detection electrode in response to the change in the angular velocity. Therefore, an inertial sensor such as the angular velocity sensor has difficulty in achieving both an improvement in the sensitivity and a wide detection range.

### CITATION LIST

### Patent Literature

Patent Literature 1: JP 2011-209270 A

### SUMMARY OF INVENTION

It is an object to provide an inertial sensor having increased sensitivity in a desired range with an extended detection range of an inertial force.

An inertial sensor according to an aspect of the present disclosure includes: a plurality of inertial force detection elements each configured to output an output signal corresponding to a detected inertial force; and a processor configured to execute a process relating to the output signal from each of the plurality of inertial force detection elements. The plurality of inertial force detection elements include a first inertial force detection element and a second inertial force detection element. A detection range of the first inertial force detection element and a detection range of the second inertial force detection element are different from each other. A sensitivity of the first inertial force detection element and a sensitivity of the second inertial force detection element are different from each other.

### BRIEF DESCRIPTION OF DRAWINGS

FIG. 1 is a block diagram of an inertial sensor according to an embodiment of the present disclosure;

FIG. 2 is a schematic plan view of the inertial sensor;

FIG. 3 is a schematic sectional view of the inertial sensor;

FIG. 4 is a flowchart of an example of a process executed by a processor of the inertial sensor;

FIG. 5 is a flowchart of another example of the process executed by the processor of the inertial sensor;

FIG. 6 is a block diagram of an inertial sensor according to a variation;

FIG. 7 is a schematic plan view of the inertial sensor according to the variation; and

FIG. 8 is a schematic sectional view of the inertial sensor according to the variation;

### DESCRIPTION OF EMBODIMENTS

An embodiment of the present disclosure will be described hereinafter with reference to the drawings in some cases. The embodiment described below is illustrative for describing the present disclosure and is not intended to limit the present disclosure to the following contents. The relative positions and other positional relationships comply with the drawings unless otherwise specified. Note that the drawings to be referred to in the following description of the embodiment are all schematic representations, that is, the ratio of the dimensions (including thicknesses) of respective constituent elements illustrated on the drawings does not always reflect their actual dimensional ratio. In addition, the dimensional ratio of each element is not limited to the ratio illustrated in the drawings.

In the present disclosure, an inertial sensor is a sensor that detects an inertial force. The inertial force is expressed in acceleration in the translationally accelerated system and in an angular velocity in the rotating coordinate system. That is, detection of the inertial force means detection of at least one of the acceleration or the angular velocity. In this regard, the inertial sensor is a sensor that detects at least one of the acceleration or the angular velocity.

(1) Embodiment

(1-1) Overview

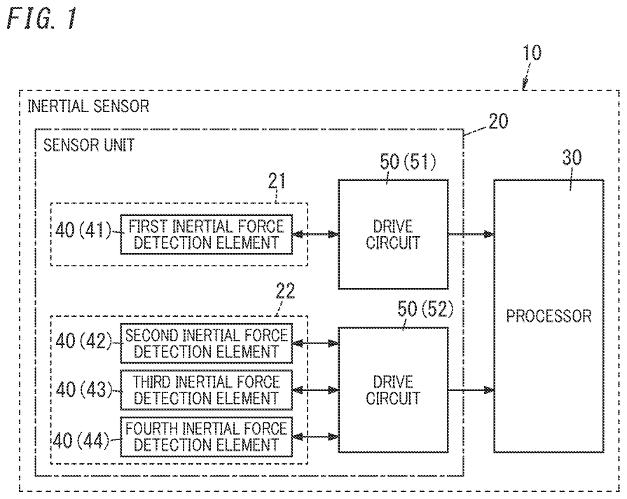

FIG. 1 is a block diagram of an inertial sensor 10 according to the present embodiment. The inertial sensor 10 includes a plurality of inertial force detection elements 40 and a processor 30. The plurality of inertial force detection elements 40 output signals corresponding to respective detected inertial forces. The processor 30 executes a process relating to the output signals from the plurality of inertial force detection elements 40. The plurality of inertial force detection elements 40 include a first inertial force detection element 41 and a second inertial force detection element 42. The first inertial force detection element 41 and the second inertial force detection element 42 have detection ranges different from each other. The first inertial force detection element 41 and the second inertial force detection element 42 have sensitivities different from each other.

In the inertial sensor 10 of the present embodiment, the first inertial force detection element 41 and the second inertial force detection element 42 which detect inertial forces of detection axes (predetermined axes) parallel to each other have the detection ranges different from each other and have the sensitivities different from each other. Thus, the detection range of the inertial sensor 10 as a whole can be wider than that in the case where the first inertial force detection element 41 and the second inertial force detection element 42 have the same detection ranges. Further, the inertial sensor 10 has the detection range of one inertial force detection element of the first inertial force detection element 41 and the second inertial force detection element 42, the one inertial force detection element having higher sensitivity than the other of the first inertial force detection element 41 and the second inertial force detection element 42. Thus, the sensitivity of the inertial sensor 10 as a whole can be improved more than that in the case where the first inertial force detection element 41 and the second inertial force detection element 42 have the same sensitivities. Therefore, the inertial sensor 10 of the present embodiment has increased sensitivity while the detection range of the inertial force is extended.

(1-2) Details

The inertial sensor 10 according to the present embodiment will be described hereinafter in detail referring to the drawings.

As shown in FIG. 1, the inertial sensor 10 includes a sensor unit 20 and the processor 30.

The sensor unit 20 includes the plurality of inertial force detection elements 40 and a plurality of drive circuits 50.

The plurality of inertial force detection elements 40 detect inertial forces and output output signals corresponding to the respective inertial forces thus detected. Each of the plurality of inertial force detection elements 40 is a mechano-electrical transduction element (e.g., Micro Electro Mechanical Systems: MEMS). Each of the plurality of inertial force detection elements 40 is an angular velocity detection element. Each of the plurality of inertial force detection elements 40 detects an angular velocity as the inertial force. Since the structure of each inertial force detection element 40 may be a structure of a conventionally well-known angular velocity detection element, the detailed description thereof will be omitted.

The plurality of inertial force detection elements 40 include the first inertial force detection element 41, the second inertial force detection element 42, a third inertial force detection element 43, and a fourth inertial force detection element 44.

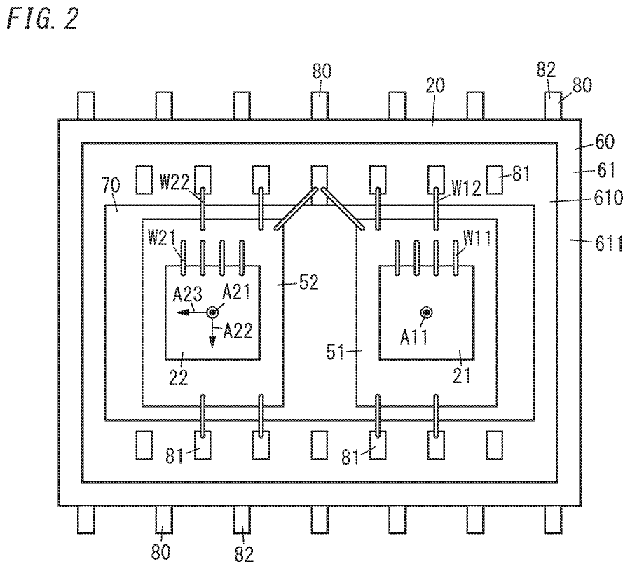

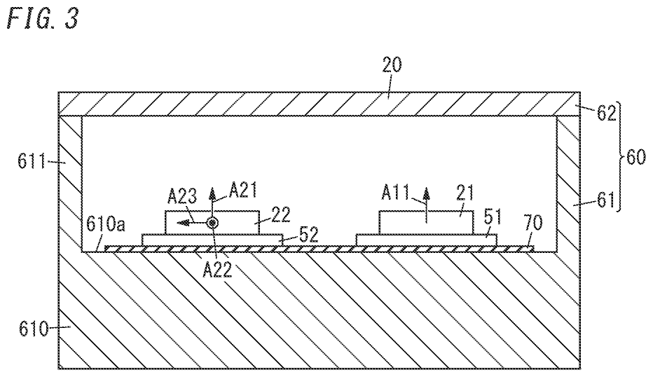

The first inertial force detection element 41 detects an inertial force of a first axis A11 (see FIGS. 2 and 3) and outputs an output signal corresponding to the inertial force thus detected. In the present embodiment, the first inertial force detection element 41 is an angular velocity detection element. The inertial force of the first axis A11 is an angular velocity around the first axis A11.

The second inertial force detection element 42 detects an inertial force of a first axis A21 (see FIGS. 2 and 3) and outputs an output signal corresponding to the inertial force thus detected. In the present embodiment, the second inertial force detection element 42 is an angular velocity detection element. The inertial force of the first axis A21 is an angular velocity around the first axis A21.

The third inertial force detection element 43 detects an inertial force of a second axis A22 (see FIGS. 2 and 3) and outputs an output signal corresponding to the inertial force thus detected. The second axis A22 is orthogonal to the first axis A21. In the present embodiment, the third inertial force detection element 43 is an angular velocity detection element. The inertial force of the second axis A22 is an angular velocity around the second axis A22.

The fourth inertial force detection element 44 detects an inertial force of a third axis A23 (see FIGS. 2 and 3) and outputs an output signal corresponding to the inertial force thus detected. The third axis A23 is orthogonal to each of the first axis A21 and the second axis A22. In the present embodiment, the fourth inertial force detection element 44 is an angular velocity detection element. The inertial force of the third axis A23 is an angular velocity around the third axis A23.

As shown in FIGS. 2 and 3, the first axis A11 and the first axis A21 are parallel to each other. In the present embodiment, the distance between the first axis A11 and the first axis A21 is in a range in which the angular velocity around the first axis A11 and the angular velocity around the first axis A21 can be regarded as substantially equal to each other. Therefore, the first inertial force detection element 41 and the second inertial force detection element 42 detect inertial forces of the same axes (predetermined axes). In the present embodiment, the predetermined axes are axes corresponding to the first axis A11 and the first axis A21. Thus, the first inertial force detection element 41 and the second inertial force detection element 42 respectively detect the inertial forces of the first axes A11 and A21. The first axis A11 is an axis in an element vertical direction of the first inertial force detection element 41 (axis orthogonal to an arrangement surface (element arrangement surface) 610a described later). The first axis A21 is an axis in an element vertical direction of the second inertial force detection element 42 (axis orthogonal to the arrangement surface (element arrangement surface)). The first axis A11 and the first axis A21 are axes parallel to each other.

The first inertial force detection element 41 and the second inertial force detection element 42 have detection ranges different from each other. The detection range is a detection range of the inertial force (the angular velocity in the present embodiment). In particular, in the present embodiment, the detection range is intended to a range in which a change in the output signal of each inertial force detection element 40 in response to the change in the inertial force is regarded as having linearity. In the present embodiment, the detection range of the first inertial force detection element 41 is narrower than the detection range of the second inertial force detection element 42. For example, the detection range of the first inertial force detection element 41 is 0 to 50 [deg/sec], and the detection range of the second inertial force detection element 42 is 0 to 200 [deg/sec].

The first inertial force detection element 41 and the second inertial force detection element 42 have sensitivities different from each other. The sensitivity is, for example, the amount of change in the output with respect to a unit input. As for the angular velocity, the sensitivity is the amount of change in the output signal when the angular velocity changes by 1 “deg/sec”. The higher the sensitivity, the easier a minute change in the angular velocity is detected. In the present embodiment, the sensitivity of the first inertial force detection element 41 is higher than the sensitivity of the second inertial force detection element 42.

The first inertial force detection element 41 and the second inertial force detection element 42 have bias stabilities different from each other. The bias stability is, for example, the magnitude of the variation in the output signal when the inertial force is zero (at rest). High bias stability reduces erroneous detection when the inertial force is zero. In the present embodiment, the bias stability of the first inertial force detection element 41 is higher than the bias stability of the second inertial force detection element 42.

The third inertial force detection element 43 and the fourth inertial force detection element 44 are equivalent to the second inertial force detection element 42 in terms of the detection range, sensitivity, and bias stability. In other words, the second inertial force detection element 42, the third inertial force detection element 43 and the fourth inertial force detection element 44 may be the same except for the axes of which the inertial forces are detected. Thus, the detection range of the first inertial force detection element 41 is narrower than the detection range of each of the third inertial force detection element 43 and the fourth inertial force detection element 44. The sensitivity of the first inertial force detection element 41 is higher than that of each of the third inertial force detection element 43 and the fourth inertial force detection element 44. The bias stability of the first inertial force detection element 41 is higher than that of each of the third inertial force detection element 43 and the fourth inertial force detection element 44.

The plurality of drive circuits 50 give the output signals from the plurality of inertial force detection elements 40 to the processor 30. In the present embodiment, the plurality of drive circuits 50 drive the plurality of inertial force detection elements 40 to cause the plurality of inertial force detection elements 40 to output signals corresponding to the respective inertial forces thus detected. Each of the plurality of drive circuits 50 is, for example, an Application Specific Integrated Circuit (ASIC). Since the structure of each drive circuit 50 may be the structure of a drive circuit for conventionally well-known angular velocity detection elements, the detailed description thereof will be omitted.

The plurality of drive circuits 50 include two drive circuits 51 and 52. The drive circuit (first drive circuit) 51 acquires the output signal from the first inertial force detection element 41 and gives the output signal to the processor 30. The drive circuit (second drive circuit) 52 acquires the output signals from the second to fourth inertial force detection elements 42 to 44 and gives the output signals to the processor 30. As shown in FIGS. 2 and 3, each of the two drive circuits 51 and 52 is generally rectangular plate-shaped.

As shown in FIGS. 1 to 3, the sensor unit 20 includes two sensor elements 21 and 22. The sensor element 21 includes the first inertial force detection element 41 of the plurality of inertial force detection elements 40. The sensor element 22 includes the second inertial force detection element 42, the third inertial force detection element 43, and the fourth inertial force detection element 44 of the plurality of inertial force detection elements 40. The second inertial force detection element 42, the third inertial force detection element 43, and the fourth inertial force detection element 44 are integrated into one piece. As shown in FIGS. 2 and 3, the two sensor elements 21 and 22 are generally rectangular plate-shaped.

The sensor unit 20 further includes a package 60 as shown in FIGS. 2 and 3.

The package 60 houses the two sensor elements 21 and 22 and the two drive circuits 51 and 52. The package 60 includes a base 61 and a cover 62. The two sensor elements 21 and 22 and the two drive circuits 51 and 52 are housed in a space between the base 61 and the cover 62. In FIG. 2, the cover 62 is omitted.

The base 61 includes a base part 610 and a sidewall part 611. Both the base part 610 and the sidewall part 611 are electrically insulating. The base part 610 and the sidewall part 611 are formed as a continuous one piece. For example, the base part 610 and the sidewall part 611 are a molded article made of an electrically insulating resin. The base part 610 has the arrangement surface 610a. The arrangement surface 610a is a surface (element arrangement surface) on which the two sensor elements 21 and 22 and the two drive circuits 51 and 52 are arranged. The base part 610 has a rectangular plate shape. The base part 610 has a surface constituting the arrangement surface 610a. The surface is one surface in a thickness direction. The sidewall part 611 protrudes from the outer periphery of the one surface in the thickness direction defined with respect to the base part 610. The sidewall part 611 has a rectangular frame shape. The cover 62 is attached to the sidewall part 611 so as to face the arrangement surface 610a of the base part 610. The cover 62 has a rectangular plate shape. The cover 62 is electrically insulating. For example, the cover 62 is a molded article made of an electrically insulating resin.

The base 61 further includes an anti-vibration portion 70 and a plurality of connecting members 80.

The anti-vibration portion 70 is arranged on the arrangement surface 610a of the base 61. In particular, the anti-vibration portion 70 lies between the arrangement surface 610a and the two sensor elements 21 and 22 and the two drive circuits 51 and 52. The anti-vibration portion 70 is provided to reduce the influence of a vibration outside the package 60 on the two sensor elements 21 and 22. This reduces noise generated in the inertial sensor 10. For example, the anti-vibration portion 70 is made of an elastic and electrically insulating material.

The plurality of connecting members 80 are used for electrical connection of at least the drive circuits 51 and 52 to the processor 30. Each of the plurality of connecting members 80 includes an electrode portion 81 and a terminal portion 82. The plurality of connecting members 80 are embedded in the base 61. In each connecting member 80, the electrode portion 81 is exposed at the arrangement surface 610a of the base part 610, the terminal portion 82 protrudes outward from a side surface of the base part 610. The electrode portions 81 of the plurality of connecting members 80 are used for electrical connection to the drive circuits 51 and 52. The terminal portions 82 of the plurality of connecting members 80 are used for electrical connection to the processor 30. In the present embodiment, the plurality of connecting members 80 are held by the base 61 by insert molding.

The two sensor elements 21 and 22 and the two drive circuits 51 and 52 are arranged on the arrangement surface 610a. As shown in FIGS. 2 and 3, the two drive circuits 51 and 52 are arranged on the anti-vibration portion 70 on the arrangement surface 610a. In the present embodiment, the two drive circuits 51 and 52 are aligned along the length direction (left/right direction in FIG. 2) of the arrangement surface 610a. The two sensor elements 21 and 22 are arranged on opposite sides respectively of the two drive circuits 51 and 52 from the arrangement surface 610a. The sensor element 21 is electrically connected to the first drive circuit 51 by one or more conductive wires W11. The sensor element 22 is electrically connected to the second drive circuit 52 by one or more conductive wires W21. The first drive circuit 51 is electrically connected to corresponding one or more of the electrode portions 81 respectively by one or more conductive wires W12. The second drive circuit 52 is electrically connected to corresponding one or more of the electrode portions 81 respectively by one or more conductive wires W22.

In this embodiment, as shown in FIGS. 2 and 3, the first axis A11 of the first inertial force detection element 41 and the first axis A21 of the second inertial force detection element 42 are orthogonal to the arrangement surface 610a. The second axis A22 of the third inertial force detection element 43 is along the width direction of the arrangement surface 610a (up/down direction in FIG. 2). In particular, the second axis A22 of the third inertial force detection element 43 is orthogonal to a direction in which the two sensor elements 21 and 22 (two drive circuits 51 and 52) are aligned (left/right direction in FIG. 2). The third axis A23 of the fourth inertial force detection element 44 is along the length direction of the arrangement surface 610a (left/right direction in FIG. 2). In particular, the third axis A23 of the fourth inertial force detection element 44 is orthogonal to a direction in which the two sensor elements 21 and 22 (two drive circuits 51 and 52) are aligned (left/right direction in FIG. 2).

The processor 30 executes a process relating to the output signals from the plurality of inertial force detection elements 40. The processor 30 acquires, from the drive circuits 51 and 52, the output signals from the plurality of inertial force detection elements 40. The processor 30 acquires the output signal from the first inertial force detection element 41 at a first interval and acquires the output signal from the second inertial force detection element 42 at a second interval wider than the first interval. This is because the sensitivity of the first inertial force detection element 41 is higher than that of the second inertial force detection element 42. In the present embodiment, the second inertial force detection element 42, the third inertial force detection element 43, and the fourth inertial force detection element 44 are integrated into the sensor element 22. Therefore, the processor 30 acquires the output signals from the second to fourth inertial force detection elements 42 to 44 at the second interval. The first interval and the second interval are at least accordingly set in accordance with the sensitivities of the first and second inertial force detection elements 41 and 42. Incidentally, reducing the first interval to be shorter than an interval based on the ratio of the sensitivities of the first and second inertial force detection elements 41 and 42 enables a first inertial force to be finely output. Further, depending on a required resolution, the second interval may be made shorter than the ratio of the sensitivities of the first and second inertial force detection elements 41 and 42.

The processor 30 obtains the inertial force of the predetermined axis (first axis A11) with reference to the output signal from the first inertial force detection element 41. In sum, the processor 30 obtains the inertial force of the first axis A11 (angular velocity around the first axis A11) with reference to the output from the sensor element 21, that is, the angular velocity of the one axis. The processor 30 obtains the inertial force of the predetermined axis (first axis A21) with reference to the output signal from the second inertial force detection element 42. The processor 30 obtains the inertial force of the second axis A22 with reference to the output signal from the third inertial force detection element 43. The processor 30 obtains the inertial force of the third axis A23 with reference to the output signal from the fourth inertial force detection element 44. In sum, the processor 30 obtains the inertial forces of the first to third axes A21 to A23 (angular velocities around the first to third axes A21 to A23), that is, the angular velocities of the three axis with reference to the output from the sensor element 22.

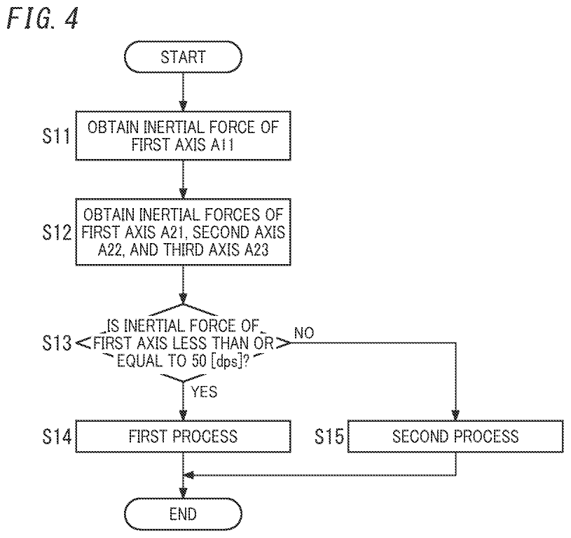

An example of the processing by the processor 30 will be described with reference to the flowchart of FIG. 4. First, the processor 30 obtains the inertial force (angular velocity) of the first axis A11 from the output signal of the first inertial force detection element 41 (S11). The processor 30 obtains inertial force (angular velocities) of the first axis A21, the second axis A22, and the third axis A23 from the output signals of the second inertial force detection element 42, the third inertial force detection element 43, and the fourth inertial force detection element 44 (S12). Then, the processor 30 determines whether or not the inertial force of the first axis is less than or equal to 50 [dps] (S13). The inertial force of the first axis may be any of the inertial force of the first axis A11 from the first inertial force detection element 41 and the inertial force of the first axis A21 from the second inertial force detection element 42. Using the inertial force from the first inertial force detection element 41 (inertial force of the first axis A11) enables inertial force to be more finely detected, thereby improving the determination accuracy. Here, if the inertial force of the first axis is less than or equal to 50 [dps] (first range) (S13: YES), the processor 30 performs a first process (S14). In the first process, the processor 30 performs processing with reference to the inertial forces output from the plurality of inertial force detection elements 40. In the first process, the processor 30 selects the angular velocity of the first axis A11, the angular velocity of the second axis A22, and the angular velocity of the third axis A23 as the inertial forces output from the plurality of inertial force detection elements 40. That is, the first process is a process of outputting the inertial force of the first axis A11 obtained with reference to the output signal from the first inertial force detection element 41, the inertial force of the second axis A22 obtained with reference to the output signal from the third inertial force detection element 43, and the inertial force of the third axis A33 obtained with reference to the output signal from the fourth inertial force detection element 44. On the other hand, if the inertial force of the first axis is greater than 50 [dps] (second range) (S13: NO), the processor 30 performs a second process (S15). In the second process, the processor 30 performs processing with reference to the inertial forces output from the plurality of inertial force detection elements 40. In the second process, the processor 30 selects the angular velocity of the first axis A21, the angular velocity of the second axis A22, and the angular velocity of the third axis A23 as the inertial forces output from the plurality of inertial force detection elements 40. That is, the second process is a process of outputting the inertial forces of the first axis A21, the second axis A22, and the third axis A23 obtained with reference to the output signals from the second inertial force detection element 42, the third inertial force detection element 43, and the fourth inertial force detection element 44. Thus, the angular velocities of the three axes are output in each of the first process and the second process, but the inertial force detection element of one of the three axes is different between the first process and the second process.

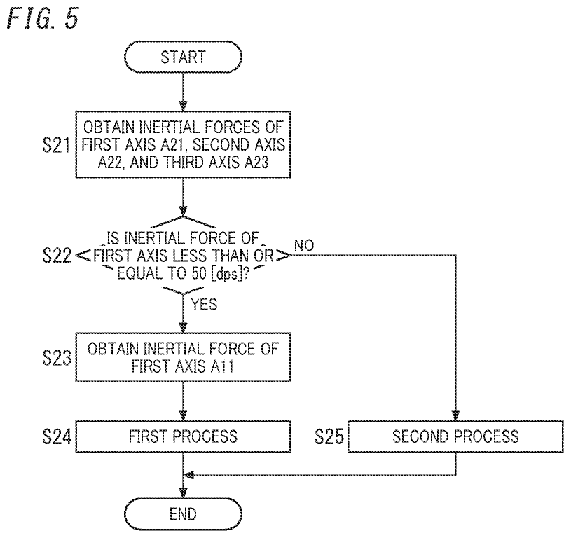

Another example of the process by the processor 30 will be described with reference to the flowchart of FIG. 5. First of all, the processor 30 obtains inertial forces (angular velocities) of the first axis A21, the second axis A22, and the third axis A23 from the output signals of the second inertial force detection element 42, the third inertial force detection element 43, and the fourth inertial force detection element 44 (S21). Then, the processor 30 determines whether or not the inertial force of the first axis A21 is less than or equal to 50 [dps] (S22). Then, if the inertial force of the first axis A21 is less than or equal to 50 [dps] (first range) (S22; YES), the processor 30 obtains the inertial force (angular velocity) of the first axis A11 from the output signal of the first inertial force detection element 41 (S23). Thereafter, the processor 30 performs a first process (S24). In the first process, the processor 30 performs processing with reference to the inertial forces output from the plurality of inertial force detection elements 40. In the first process, the processor 30 selects the angular velocity of the first axis A11, the angular velocity of the second axis A22, and the angular velocity of the third axis A23 as the inertial forces output from the plurality of inertial force detection elements 40. That is, the first process is a process of outputting the inertial force of the first axis A11 obtained with reference to the output signal from the first inertial force detection element 41, the inertial force of the second axis A22 obtained with reference to the output signal from the third inertial force detection element 43, and the inertial force of the third axis A33 obtained with reference to the output signal from the fourth inertial force detection element 44. If the inertial force of the first axis A21 is greater than 50 [dps] (second range) (S22; NO), the processor 30 performs a second process (S25). The content of the second process is the same as the second process of the flowchart shown in FIG. 4. According to the example shown in the flowchart of FIG. 5, the inertial forces of the three axes suffice as data of the inertial force to be stored in memory at the time of the processing compared to the example shown in the flowchart of FIG. 4, and thus, when the first inertial force is greater than 50 [dps], one process can be reduced. Therefore, the processing can be efficiently performed.

The processor 30 executes the first process in the first range of the inertial force. The processor 30 executes the second process in the second range of the inertial force. The first range is a range within the detection range of the first inertial force detection element 41. The second range is a range within the detection range of the second inertial force detection element 42. In particular, the first range is a range overlapping the detection range of the first inertial force detection element 41 and the detection range of the second inertial force detection element 42. The second range is a range that is in the detection range of the second inertial force detection element 42 and that does not overlap with the first range. The upper limit value of the first range is less than or equal to the lower limit value of the second range. In the present embodiment, the first range is a range in which the angular velocities of the predetermined axes (the first axes A11 and A21) are each greater than or equal to 0 and less than or equal to 50 [dps], and the second range is a range in which the angular velocities are each greater than 50 and less than or equal to 200 [dps]. The inertial force (angular velocity) and the output from the processor 30 are in the relationship as shown in Table 1. That is, when the first process is executed, the range (first range) of the corresponding inertial force is greater than or equal to 0 [dps] and less than or equal to 50 [dps], but the detection sensitivity of the inertial force and the bias stability are increased. Further, when the second process is executed, the detection sensitivity of the inertial force and the bias stability is relatively low, but the range (second range) of the corresponding inertial force is greater than 50 [dps] and less than or equal to 200 [dps] and can thus be extended. Note that [dps] is “degree per seconds”.

TABLE 1

| Inertial | | | | |
|---|---|---|---|---|
| Force | | | | |
| (Angular | Process | | | |
| Velocity | to be | | | Bias |
| [dps]) | Executed | Output | Sensitivity | Stability |
| Greater | First | Angular Velocity of First Axis A11 | High | High |
| than or | Process | Angular Velocity of Second Axis A22 | | |
| equal to 0 | | Angular Velocity of Third Axis A23 | | |
| and less | | | | |
| than or | | | | |
| equal to 50 | | | | |
| Greater | Second | Angular Velocity of First Axis A21 | Low | Low |
| than 50 | Process | Angular Velocity of Second Axis A22 | | |
| and less | | Angular Velocity of Third Axis A23 | | |
| than or | | | | |
| equal to | | | | |
| 200 | | | | |

The processor 30 executes a diagnostic process in the first range. The diagnostic process is a process of performing a failure diagnosis for the first inertial force detection element 41 with reference to the output signal from the second inertial force detection element 42. The first range overlaps the detection range of the first inertial force detection element 41 and the detection range of the second inertial force detection element 42. Therefore, in the first range, usually, the inertial force obtainable from the output signal from the first inertial force detection element 41 (the angular velocity around the first axis A11) is equal to the inertial force obtainable from the output signal from the second inertial force detection element 42 (the angular velocity around the first axis A21). Thus, in the first range, the second inertial force detection element 42 whose sensitivity is lower than that of the first inertial force detection element 41 can be utilized in the failure diagnosis for the first inertial force detection element 41. If the angular velocity around the first axis A11 does not match the angular velocity around the first axis A21, the processor 30 determines that the first inertial force detection element 41 has a failure. If it is determined, as a result of the diagnostic process, that the first inertial force detection element 41 has a failure, the processor 30 outputs an angular velocity around the first axis A21 instead of the angular velocity around the first axis A11. Therefore, even in case of a failure in the first inertial force detection element 41, the inertial sensor 10 can continue operating. If it is determined, as a result of the diagnostic process, that the first inertial force detection element 41 has a failure, the processor 30 further notifies the occurrence of the failure.

(2) Variations

The embodiment of the present disclosure is not limited to the embodiment described above. The embodiment described above may be readily modified in various manners depending on a design choice or any other factor without departing from the scope of the present disclosure. Variations of the embodiment described above will be enumerated below. The variations described below are applicable accordingly in combination.

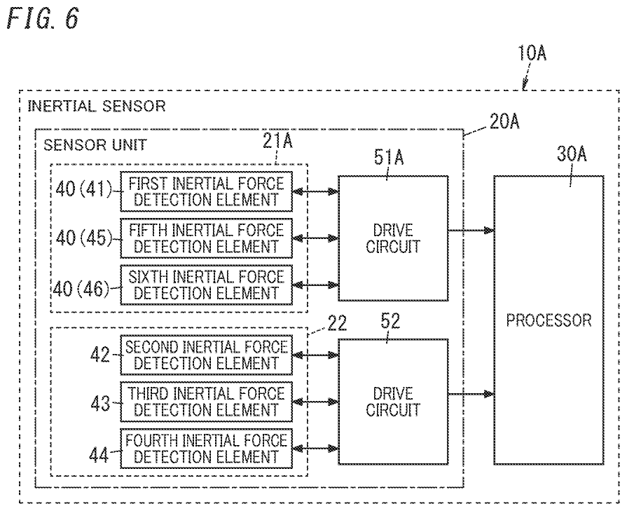

FIGS. 6 to 8 show an inertial sensor 10A of a variation. As shown in FIG. 6, the inertial sensor 10A includes a sensor unit 20A and a processor 30A.

The sensor unit 20A includes a plurality of inertial force detection elements 40 and a plurality of drive circuits 50 (51A and 52).

The plurality of inertial force detection elements 40 includes a first inertial force detection element 41, a second inertial force detection element 42, a third inertial force detection element 43, a fourth inertial force detection element 44, a fifth inertial force detection element 45, and a sixth inertial force detection element 46.

The first inertial force detection element 41 to the fourth inertial force detection element 44 are the same as those in the embodiment described above.

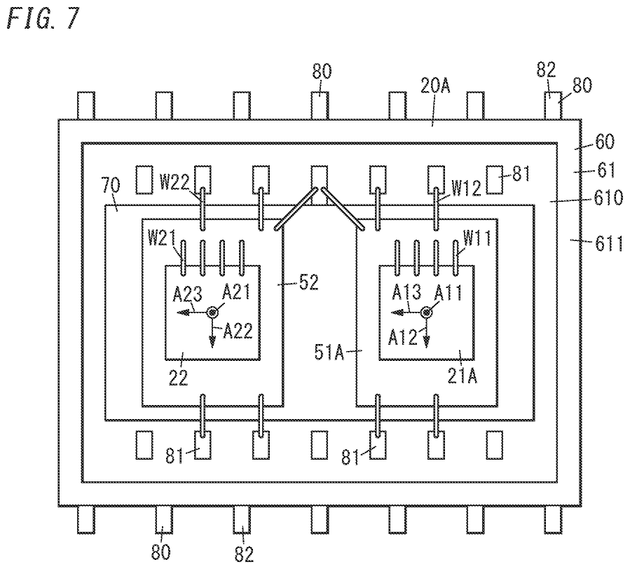

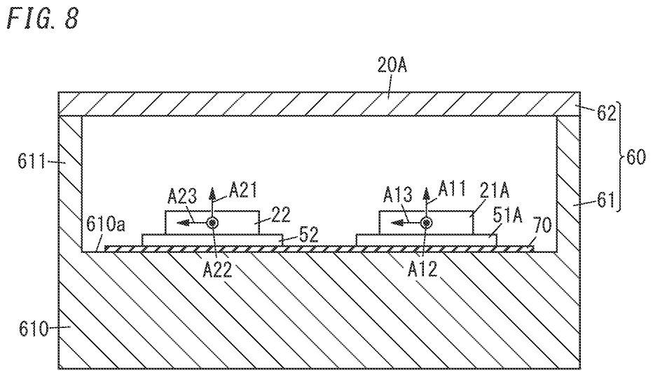

The fifth inertial force detection element 45 detects inertial force of a second axis A12 (see FIGS. 7 and 8) and outputs an output signal corresponding to the inertial force thus detected. The second axis A12 is orthogonal to a first axis A11. In the present variation, the fifth inertial force detection element 45 is an angular velocity detection element. The inertial force of the second axis A12 is an angular velocity around the second axis A12.

The sixth inertial force detection element 46 detects inertial force of a third axis A13 (see FIGS. 7 and 8) and outputs an output signal corresponding to the inertial force thus detected. The third axis A13 is orthogonal to each of the first axis A11 and the second axis A12. In the present variation, the sixth inertial force detection element 46 is an angular velocity detection element. The inertial force of the third axis A13 is an angular velocity around the third axis A13.

As shown in FIGS. 7 and 8, the second axis A12 and a second axis A22 are parallel to each other. In the present variation, the distance between the second axis A12 and the second axis A22 is in a range in which the angular velocity around the second axis A12 and an angular velocity around the second axis A22 can be regarded as being substantially equal to each other. Therefore, the third inertial force detection element 43 and the fifth inertial force detection element 45 detect inertial forces of the same axes (predetermined axes). In the present variation, the axes corresponding to the second axis A12 and the second axis A22 are also predetermined axes.

As shown in FIGS. 7 and 8, the third axis A13 and a third axis A23 are parallel to each other. In the present variation, the distance between the third axis A13 and the third axis A23 is in a range in which the angular velocity around the third axis A13 and an angular velocity around the third axis A23 can be regarded as being substantially equal to each other. Therefore, the fourth inertial force detection element 44 and the sixth inertial force detection element 46 detect inertial forces of the same axes (predetermined axes). In the present variation, the axes corresponding to the third axis A13 and the third axis A23 are also predetermined axes.

The fifth inertial force detection element 45 and the sixth inertial force detection element 46 are equivalent to the first inertial force detection element 41 in terms of the detection range, sensitivity, and bias stability. In other words, the first inertial force detection element 41, the fifth inertial force detection element 45, and the sixth inertial force detection element 46 may be the same except for the axes of which the inertial forces are detected. Thus, the detection range of each of the fifth inertial force detection element 45 and the sixth inertial force detection element 46 is narrower than that of each of the second to fourth inertial force detection elements 42 to 44. Thus, the sensitivity of each of the fifth inertial force detection element 45 and the sixth inertial force detection element 46 is higher than that of each of the second to fourth inertial force detection elements 42 to 44. Thus, the bias stability of each of the fifth inertial force detection element 45 and the sixth inertial force detection element 46 is higher than that of each of the second to fourth inertial force detection elements 42 to 44.

The plurality of drive circuits 50 includes the two drive circuits 51A and 52. The first drive circuit 51A acquires output signals from the first, fifth, and sixth inertial force detection elements 41, 45, and 46 and gives the output signals to the processor 30A. The first drive circuit 51A is generally rectangular plate-shaped.

As shown in FIGS. 6 to 8, the sensor unit 20A includes two sensor elements 21A and 22. The sensor element 21A includes the first inertial force detection element 41, the fifth inertial force detection element 45, and the sixth inertial force detection element 46 of the plurality of inertial force detection elements 40. The first inertial force detection element 41, the fifth inertial force detection element 45, and the sixth inertial force detection element 46 are integrated into one piece. As shown in FIGS. 7 and 8, the two sensor elements 21A and 22 are generally rectangular plate-shaped.

The processor 30A executes a process relating to the output signals from the plurality of inertial force detection elements 40. The processor 30 acquires, from the drive circuits 51A and 52, the output signals from the plurality of inertial force detection elements 40. The processor 30A acquires the output signal from the first inertial force detection element 41 at a first interval and acquires the output signal from the second inertial force detection element 42 at a second interval wider than the first interval. In the present variation, the first inertial force detection element 41, the fifth inertial force detection element 45, and the sixth inertial force detection element 46 are integrated into the sensor element 21A. Therefore, the processor 30A acquires the output signals from the first, fifth, and sixth inertial force detection elements 41, 45, and 46 at the first interval.

The processor 30A obtains the inertial force of the first axis A11 with reference to the output signal from the first inertial force detection element 41. The processor 30A obtains the inertial force of the second axis A12 with reference to the output signal from the fifth inertial force detection element 45. The processor 30A obtains the inertial force of the third axis A13 with reference to the output signal from the sixth inertial force detection element 46. In sum, the processor 30A obtains the inertial forces of the first to third axes A11 to A13 (angular velocities around the first to third axes A11 to A13), that is, the angular velocities of the three axis with reference to the output from the sensor element 21A.

In a similar manner to the processor 30, the processor 30A obtains the inertial forces of the first to third axes A21 to A23 (angular velocities around the first to third axes A21 to A23), that is, the angular velocities of the three axis with reference to the output from the sensor element 22.

The processor 30A has a function of executing a first process and a second process. The first process is a process of outputting the inertial forces obtained with reference to the output signals from the first, fifth, and sixth inertial force detection elements 41, 45, and 46. The second process is a process of outputting the inertial forces obtained with reference to the output signals from the second to fourth inertial force detection elements 42 to 44. Therefore, the angular velocities of the three axes are output in the first process and the second process.

The processor 30A executes the first process in a first range of the inertial force and executes the second process in a second range of the inertial force. The first range and the second range are the same as those in the embodiment described above. The inertial force (angular velocity) and the output from the processor 30A are in the relationship as shown in Table 2. The first range and the second range are not limited to the angular velocities of the first axes A11 and A21 but may be set based on the angular velocities of the second axes A12 and A22 or the angular velocities of the third axes A13 and A23.

TABLE 2

| Inertial | | | | |
|---|---|---|---|---|
| Force | | | | |
| (Angular | Process | | | |
| Velocity | to be | | | Bias |
| [dps]) | Executed | Output | Sensitivity | Stability |
| Greater | First | Angular Velocity of First Axis A11 | High | High |
| than or | Process | Angular Velocity of Second Axis A12 | | |
| equal to 0 | | Angular Velocity of Third Axis A13 | | |
| and less | | | | |
| than or | | | | |
| equal to 50 | | | | |
| Greater | Second | Angular Velocity of First Axis A21 | Low | Low |
| than 50 | Process | Angular Velocity of Second Axis A22 | | |
| and less | | Angular Velocity of Third Axis A23 | | |
| than or | | | | |
| equal to | | | | |
| 200 | | | | |

In a similar manner to the processor 30, the processor 30A switches between the first process and the second process with reference to the output signal from the first inertial force detection element 41 and the output signal from the second inertial force detection element 42. The processor 30A may switch between the first process and the second process with reference to the output signal from the fifth inertial force detection element 45 and the output signal from the third inertial force detection element 43. Alternatively, the processor 30A may switch between the first process and the second process with reference to the output signal from the sixth inertial force detection element 46 and the output signal from the fourth inertial force detection element 44. The switching between the first process and the second process may be determined for each axis.

The processor 30A executes a diagnostic process in the first range. The diagnostic process includes a process of performing failure diagnosis for the first inertial force detection element 41 with reference to the output signal from the second inertial force detection element 42. The diagnostic process includes a process of performing failure diagnosis for the fifth inertial force detection element 45 with reference to the output signal from the third inertial force detection element 43. The diagnostic process includes a process of performing failure diagnosis for the sixth inertial force detection element 46 with reference to the output signal from the fourth inertial force detection element 44. As described above, the processor 30A performs, in the diagnostic process, failure diagnosis for an inertial force detection element 40 having high sensitivity by using an inertial force detection element 40 having low sensitivity among the plurality of inertial force detection elements 40 which detect the inertial forces of the same axes. If it is determined, as a result of the diagnostic process, that any of the first, fifth, and sixth inertial force detection elements 41, 45, and 46 has a failure, the processor 30A outputs an angular velocity from the sensor element 21A instead of the angular velocity from the sensor element 22. If it is determined, as a result of the diagnostic process, that any of the first, fifth, and sixth inertial force detection elements 41, 45, and 46 has a failure, the processor 30A further issues a notification of the occurrence of the failure.

Next, some other variations will be enumerated.

In a variation, the predetermined axes are not limited to the first axes A11 and A21. As in the variation shown in FIGS. 6 to 8, any of the first axes A11 and A21, the second axes A12 and A22, and the third axes A13 and A23 may be adopted as the predetermined axes. The predetermined axes are not limited to the first axes A11 and A21, the second axes A12 and A22, and the third axes A13 and A23 but may be axes of arbitrary angles.

In a variation, the plurality of inertial force detection elements 40 may include three or more inertial force detection elements 40 that detect the inertial forces of the predetermined axes. In this case, the three or more inertial force detection elements 40 that detect the inertial forces of the predetermined axes may be different from one another in terms of the detection range and sensitivity. In this case, the processor 30 may utilize an inertial force detection element having higher sensitivity for a smaller inertial force and may utilize an inertial force detection element having lower sensitivity for a larger inertial force. By way of example, the plurality of inertial force detection elements 40 may include an inertial force detection element having first sensitivity, an inertial force detection element having second sensitivity lower than the first sensitivity, and an inertial force detection element having third sensitivity lower than the second sensitivity. The processor 30 may output an inertial force obtainable from the inertial force detection element having the first sensitivity in the first range. The processor 30 may output an inertial force obtainable from the inertial force detection element having the second sensitivity in the second range in which the inertial force is larger than in the first range. The processor 30 may output an inertial force obtainable from the inertial force detection element having the third sensitivity in the third range in which the inertial force is larger than in the second range.

In a variation, each of the plurality of inertial force detection elements 40 may be an acceleration detection element. Each of the plurality of inertial force detection elements 40 detects an acceleration as the inertial force. The structure of each inertial force detection element may be a structure of a conventionally well-known acceleration detection element, and thus, the detailed description thereof will be omitted.

In a variation, the plurality of inertial force detection elements 40 may include a plurality of angular velocity detection elements and a plurality of acceleration detection elements. The plurality of angular velocity detection elements may include two or more angular velocity detection elements that detect angular velocity around the same axis. The plurality of acceleration detection elements may include two or more acceleration detection elements that detect accelerations of the same axes.

In a variation, the plurality of inertial force detection elements 40 do not necessarily have to be integrated into one sensor element. Each of the plurality of sensor elements may include a single inertial force detection element.

In a variation, each of the drive circuit 50 is not limited to an ASIC but may be, for example, a Field-Programmable Gate Array (FPGA) or may be configured by one or more processors and one or more memory elements. One drive circuit 50 may control a plurality of sensor elements.

In a variation, in the inertial sensor 10, the plurality of inertial force detection elements 40 include at least the first inertial force detection element 41 and the second inertial force detection element 42 and do not have to necessarily include the third and fourth inertial force detection elements 43 and 44.

In a variation, the processor 30 may switch between the first process and the second process depending on whether or not the inertial force obtainable from the output signal from the first inertial force detection element 41 is in the first range. The processor 30 may switch between the first process and the second process depending on whether the inertial force obtainable from the output signal from the second inertial force detection element 42 is in the first range or in the second range. In sum, the processor 30 may switch between the first process and the second process with reference to at least one of the output signal from the first inertial force detection element 41 or the output signal from the second inertial force detection element 42.

In a variation, the first range does not necessarily have to overlap the detection range of the first inertial force detection element 41 and the detection range of the second inertial force detection element 42. The second range does not necessarily have to be a range that does not overlap the first range in the detection range of the second inertial force detection element 42. The first range and the second range may be appropriately set according to the application and the like of the inertial sensor 10.

In a variation, in the diagnostic process, the processor 30 does not have to perform the failure diagnosis for the first inertial force detection element 41 with reference to the second inertial force detection element 42. The processor 30 may perform failure diagnosis for the second inertial force detection element 42 with reference to the first inertial force detection element 41, and if the inertial force of the first inertial force detection element 41 and the inertial force of the second inertial force detection element 42 do not match, the processor 30 may determine that the inertial sensor 10 itself has a failure.

In a variation, also when it is determined, as a result of the diagnostic process, that the first inertial force detection element 41 has a failure, the processor 30 does not necessarily have to output the angular velocity around the first axis A21 instead of the angular velocity around the first axis A11. The processor 30 at least simply notify the occurrence of a failure. The processor 30 does not have to execute a diagnostic process in the first range.

(3) Aspects

As can be seen from the embodiment and the variations described above, the present disclosure includes the following aspects. In the following description, reference signs in parentheses are added only to clarify the correspondence relationship to the embodiment.

A first aspect is an inertial sensor (10; 10A) and includes a plurality of inertial force detection elements (40) each configured to output an output signal corresponding to a detected inertial force; and a processor (30) configured to execute a process relating to the output signal from each of the plurality of inertial force detection elements (40). The plurality of inertial force detection elements (40) include a first inertial force detection element (41) and a second inertial force detection element (42). A detection range of the first inertial force detection element (41) and a detection range of the second inertial force detection element (42) are different from each other. A sensitivity of the first inertial force detection element (41) and a sensitivity of the second inertial force detection element (42) are different from each other. This aspect enables the sensitivity to be increased in a desired range while extending a detection range of an inertial force.

A second aspect is an inertial sensor (10; 10A) according to the first aspect. In the second aspect, the inertial sensor (10; 10A) further includes a base (61) having an arrangement surface (610a) on which the first inertial force detection element (41) and the second inertial force detection element (42) are arranged. A detection axis of the first inertial force detection element (41) and a detection axis of the second inertial force detection element (42) are first axes (A11, A21) parallel to each other, and the first axes (A11, A21) are orthogonal to the arrangement surface (610a). This aspect enables the sensitivity to be increased in a desired range while extending a detection range of the inertial force.

A third aspect is an inertial sensor (10; 10A) according to the first or second aspect. In the third aspect, the detection range of the first inertial force detection element (41) is narrower than the detection range of the second inertial force detection element (42). The sensitivity of the first inertial force detection element (41) is higher than the sensitivity of the second inertial force detection element (42). This aspect enables the sensitivity to be increased in a desired range while extending a detection range of the inertial force.

A fourth aspect is an inertial sensor (10; 10A) referring to any one of the first to third aspects. In the fourth aspect, in the inertial sensor (10; 10A), the processor (30) is configured to execute a first process of outputting an inertial force obtained with reference to the output signal from the first inertial force detection element (41) in a first range and execute a second process of outputting an inertial force obtained with reference to the output signal from the second inertial force detection element (42) in a second range. This aspect enables the sensitivity to be increased in a desired range while extending a detection range of the inertial force.

A fifth aspect is an inertial sensor (10; 10A) referring to the fourth aspect. In the fifth aspect, the first range overlaps the detection range of the first inertial force detection element (41) and the detection range of the second inertial force detection element (42). The second range is a range that overlaps the detection range of the second inertial force detection element (42) and that does not overlap the first range. This aspect enables the sensitivity to be increased in a desired range while extending a detection range of the inertial force.

A sixth aspect is an inertial sensor (10; 10A) according to the fifth aspect. In the sixth aspect, the first range has an upper limit value less than or equal to a lower limit value of the second range. This aspect enables the sensitivity to be increased in a desired range while extending a detection range of the inertial force.

A seventh aspect is an inertial sensor (10; 10A) referring to any one of the fourth to sixth aspects. In the seventh aspect, the processor (30) includes a diagnostic process of performing failure diagnosis for the first inertial force detection element (41) with reference to the output signal from the second inertial force detection element (42) in the first range. This aspect enables the reliability to be improved.

An eighth aspect is an inertial sensor (10; 10A) referring to any one of the first to seventh aspects. In the eighth aspect, the processor (30) is configured to acquire the output signal from the first inertial force detection element (41) at a first interval and acquire the output signal from the second inertial force detection element (42) at a second interval wider than the first interval. This aspect enables the sensitivity to be further improved in a desired range.

A ninth aspect is an inertial sensor (10; 10A) referring to any one of the first to eighth aspects. In the ninth aspect, each of the plurality of inertial force detection elements (40) is a mechano-electrical transduction element. This aspect enables the inertial sensor (10; 10A) to be downsized.

A tenth aspect is an inertial sensor (10; 10A) referring to any one of the first to ninth aspects. In the tenth aspect, the inertial sensor (10; 10A) further includes a base (61) having an arrangement surface (610a) on which the first inertial force detection element (41) and the second inertial force detection element (42) are arranged. A detection axis of the first inertial force detection element (41) and a detection axis of the second inertial force detection element (42) are first axes (A11, A21) parallel to each other, and the first axes (A11, A21) are orthogonal to the arrangement surface (610a). The plurality of inertial force detection elements (40) further include a third inertial force detection element (43) configured to detect an inertial force of a second axis (A22) orthogonal to the first axes (A11, A21) and a fourth inertial force detection element (44) configured to detect an inertial force of a third axis (A23) orthogonal to the first axes (A11, A21) and the second axis (A22). This aspect enables the inertial forces of the three axes to be detected.

An eleventh aspect is an inertial sensor (10; 10A) referring to the tenth aspect. In the eleventh aspect, the detection range of the first inertial force detection element (41) is narrower than each of a detection range of the third inertial force detection element (43) and a detection range of the fourth inertial force detection element (44). The sensitivity of the first inertial force detection element (41) is higher than each of sensitivity of the third inertial force detection element (43) and sensitivity of the fourth inertial force detection element (44). This aspect enables the sensitivity to the inertial force of the first axes to be increased in a desired range while extending a detection range of the inertial forces of the three axes.

A twelfth aspect is an inertial sensor (10; 10A) referring to the tenth or eleventh aspect. In the twelfth aspect, the inertial sensor (10; 10A) further includes a plurality of drive circuits (50) each configured to give the output signal from a corresponding one of the plurality of inertial force detection elements (40) to the processor (30). The plurality of drive circuits (50) include a first drive circuit (51; 51A) and a second drive circuit (52). The first drive circuit (51; 51A) and the second drive circuit (52) are connected to the processor (30). The first drive circuit (51; 51A) is connected to the first inertial force detection element (41). The second drive circuit (52) is connected to the second inertial force detection element (42), the third inertial force detection element (43), and the fourth inertial force detection element (44). This aspect enables the sensitivity to the inertial force of the first axes to be increased in a desired range while extending a detection range of the inertial forces of the three axes.

A thirteenth aspect is an inertial sensor (10; 10A) referring to any one of the first to twelfth aspects. In the thirteenth aspect, the first inertial force detection element (41) and the second inertial force detection element (42) have bias stabilities different from each other. This aspect enables the sensitivity to be increased in a desired range while extending a detection range of the inertial force.

A fourteenth aspect is an inertial sensor (10; 10A) according to the twelfth aspect. In the fourteenth aspect, the inertial sensor (10; 10A) further includes a base (61) having an arrangement surface (610a) on which the first inertial force detection element (41) and the second inertial force detection element (42) are arranged. The first drive circuit (51; 51A) and the second drive circuit (52) are on the arrangement surface (610a).

A fifteenth aspect is an inertial sensor (10; 10A) according to the second or fourteenth aspect. In the fifteenth aspect, the base (61) includes an anti-vibration portion (70) lying between the arrangement surface (610a) and the plurality of inertial force detection elements (40).

### REFERENCE SIGNS LIST

10, 10A Inertial Sensor
30 Processor
40 Inertial Force Detection Element
41 First Inertial Force Detection Element
42 Second Inertial Force Detection Element
43 Third Inertial Force Detection Element
44 Fourth Inertial Force Detection Element
50 Drive Circuit
51, 51A First Drive Circuit
52 Second Drive Circuit
61 Base
610a Arrangement Surface
70 Anti-Vibration Portion
A11, A21 First Axis
A22 Second Axis
A23 Third Axis

1. An inertial sensor comprising:
a plurality of inertial force detection elements each configured to output an output signal corresponding to a detected inertial force; and
a processor configured to execute a process relating to the output signal from each of the plurality of inertial force detection elements,
the plurality of inertial force detection elements including a first inertial force detection element and a second inertial force detection element,
a detection range of the first inertial force detection element and a detection range of the second inertial force detection element being different from each other,
a sensitivity of the first inertial force detection element and a sensitivity of the second inertial force detection element being different from each other.

2. The inertial sensor of claim 1, further comprising a base having an arrangement surface on which the first inertial force detection element and the second inertial force detection element are arranged, and
a detection axis of the first inertial force detection element and a detection axis of the second inertial force detection element are first axes parallel to each other, and the first axes are orthogonal to the arrangement surface.

3. The inertial sensor of claim 1, wherein
the detection range of the first inertial force detection element is narrower than the detection range of the second inertial force detection element, and the sensitivity of the first inertial force detection element is higher than the sensitivity of the second inertial force detection element.

4. The inertial sensor of claim 1, wherein
the processor is configured to
execute a first process of outputting an inertial force obtained with reference to the output signal from the first inertial force detection element in a first range and
execute a second process of outputting an inertial force obtained with reference to the output signal from the second inertial force detection element in a second range.

5. The inertial sensor of claim 4, wherein
the first range overlaps the detection range of the first inertial force detection element and the detection range of the second inertial force detection element, and
the second range is a range that overlaps the detection range of the second inertial force detection element and that does not overlap the first range.

6. The inertial sensor of claim 5, wherein
the first range has an upper limit value less than or equal to a lower limit value of the second range.

7. The inertial sensor of claim 4, wherein
the processor is configured to execute, in the first range, a diagnostic process of performing failure diagnosis for the first inertial force detection element with reference to the output signal from the second inertial force detection element.

8. The inertial sensor of claim 1, wherein
the processor is configured to
acquire the output signal from the first inertial force detection element at a first interval and
acquire the output signal from the second inertial force detection element at a second interval wider than the first interval.

9. The inertial sensor of claim 1, wherein
each of the plurality of inertial force detection elements is a mechano-electrical transduction element.

10. The inertial sensor of claim 1, further comprising a base having an arrangement surface on which the first inertial force detection element and the second inertial force detection element are arranged, and
a detection axis of the first inertial force detection element and a detection axis of the second inertial force detection element are first axes parallel to each other, and the first axes are orthogonal to the arrangement surface, and
the plurality of inertial force detection elements further include
a third inertial force detection element configured to detect an inertial force of a second axis orthogonal to the first axes and
a fourth inertial force detection element configured to detect an inertial force of a third axis orthogonal to the first axes and the second axis.

11. The inertial sensor of claim 10, wherein
the detection range of the first inertial force detection element is narrower than each of a detection range of the third inertial force detection element and a detection range of the fourth inertial force detection element, and
the sensitivity of the first inertial force detection element is higher than each of sensitivity of the third inertial force detection element and sensitivity of the fourth inertial force detection element.

12. The inertial sensor of claim 10, further comprising a plurality of drive circuits each configured to give the output signal from a corresponding one of the plurality of inertial force detection elements to the processor, wherein
the plurality of drive circuits include a first drive circuit and a second drive circuit,
the first drive circuit and the second drive circuit are connected to the processor,
the first drive circuit is connected to the first inertial force detection element, and
the second drive circuit is connected to the second inertial force detection element, the third inertial force detection element, and the fourth inertial force detection element.

13. The inertial sensor of claim 1, wherein
the first inertial force detection element and the second inertial force detection element have bias stabilities different from each other.

14. The inertial sensor of claim 12, wherein
the first drive circuit and the second drive circuit are on the arrangement surface.

15. The inertial sensor of claim 2, wherein
the base includes an anti-vibration portion lying between the arrangement surface and the plurality of inertial force detection elements.

16. The inertial sensor of claim 14, wherein
the base includes an anti-vibration portion lying between the arrangement surface and the plurality of inertial force detection elements.

17. The inertial sensor of claim 2, wherein
the detection range of the first inertial force detection element is narrower than the detection range of the second inertial force detection element, and the sensitivity of the first inertial force detection element is higher than the sensitivity of the second inertial force detection element.

18. The inertial sensor of claim 2, wherein
the processor is configured to
execute a first process of outputting an inertial force obtained with reference to the output signal from the first inertial force detection element in a first range and
execute a second process of outputting an inertial force obtained with reference to the output signal from the second inertial force detection element in a second range.

19. The inertial sensor of claim 3, wherein
the processor is configured to
execute a first process of outputting an inertial force obtained with reference to the output signal from the first inertial force detection element in a first range and
execute a second process of outputting an inertial force obtained with reference to the output signal from the second inertial force detection element in a second range.

20. The inertial sensor of claim 17, wherein
the processor is configured to
execute a first process of outputting an inertial force obtained with reference to the output signal from the first inertial force detection element in a first range and
execute a second process of outputting an inertial force obtained with reference to the output signal from the second inertial force detection element in a second range.
